(19) United States
(12) Patent Application Publication
(10) Pub. No.: US 2002/0026423 A1
(43) Pub. Date: Feb. 28, 2002

(54) Automated usage-independent and location-independent agent-based incentive method and system for customer retention

(75) Inventors: L. Michael Maritzen, Fremont, CA (US); Harold A. Ludtke, San Jose, CA (US); Yoshihiro Tsukamura-San, Kawasaki (JP); Tomitaka Tadafusa, San Jose, CA (US)

Correspondence Address: John P. O'Banion, O'BANION & RITCHEY LLP, Suite 1550, 400 Capitol Mall, Sacramento, CA, 95814, US

(73) Assignee: SONY ELECTRONICS, INC., WOODCLIFF LAKE, NJ (US)

(21) Appl. No.: 09/737,274

(22) Filed: Dec. 12, 2000

Related U.S. Application Data
(60) Provisional application No. 60/228,009, filed on Aug. 23, 2000.

(51) Int. Cl. H04K 1/00; H04L 9/00; G06F 17/60

(52) U.S. Cl. 705/56

(57) ABSTRACT

A system and method for conducting electronic commerce transactions in which the electronic receipt and use of incentives is facilitated. By way of example, and not of limitation, the transactions are executed through a transaction clearing house mechanism and at least a portion of the exchange units associated with said transaction may be transacted to or from an escrow account that is associated with the transaction clearing house mechanism. An exchange rate mechanism automatically provides for the conversion of units of exchange that differ between the user and vendor. The system provides for the automatic, no-click, payment of invoices and bills, in addition to automatic purchases according to user preferences. Incentive programs are facilitated within the system between the user and vendor communities while preferably maintaining user anonymity.

### CROSS-REFERENCE TO RELATED APPLICATIONS

This application claims priority from U.S. provisional application Ser. No. 60/228,009 filed on Aug. 23, 2000 and incorporated herein by reference.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to electronic commerce systems and, more particularly, to methods and systems for providing agent-based enhanced electronic commerce services capable of providing consumer incentives.

2. Description of the Background Art

Electronic commerce (e-Commerce) is burgeoning and the anticipated widespread adoption of a number of aspects of e-Commerce is expected to reduce the overhead involved in the processing of commercial transactions. The data communication associated with e-Commerce may be effected over any form of interlinked computer network, such as the world wide web (Internet), as well as with wireless communication, satellite networks, interactive TV, cable networks, and so forth.

Charge and debit cards have facilitated a widely used form of electronic commerce wherein magnetic-stripes containing an account number are used for the purchase of goods and services. More recently, consumers and businesses have gained a nascent capability for making payments over the Internet, but a number of aspects of electronic commerce transactions remain cumbersome and generally involve high levels of user overhead. New consumer transaction devices, such as electronic wallets, have recently been introduced which attempt to speed both the security and expediency with which electronic transactions may be conducted. However, users are often required to navigate burdensome structures wherein the low-level paper-based task has only been converted to an electronic format and has not been structurally redefined. In the case of incentive programs, the user remains largely tied to conventional paper-based incentives, and current e-Commerce mechanisms do not facilitate the incenting of customers, or address customer retention and similar issues. Furthermore, customer anonymity cannot be readily maintained in relation to the current methods of providing customer incentives.

Therefore a need exists for an e-Commerce system capable of supporting incentives and retention programs and expedited transactions. The agent-based e-Commerce incentive method system according to the present invention satisfies that need, as well as others, and overcomes the deficiencies of current e-Commerce solutions.

### BRIEF SUMMARY OF THE INVENTION

The present invention provides e-Commerce services utilizing an agent-based model that is capable of providing pro-active incentive techniques. In particular, location independent services are provided for use with digital wallets, smart cellular phones, kiosks, personal digital assistances (PDAs), personal computers (PCs), privacy cards, and other financially enabled e-Commerce devices. These services are preferably conducted within an infrastructure level transaction model in which an agent is utilized as an intermediary so that the personal information of the user may be retained in privacy.

The methods according to the present invention can be applied to any business process or e-Commerce model that involves the exchange of value, such as the receipt and disbursement of monetary units. The system provides mechanisms for fully automating both purchases and payments from an e-Commerce device through internet-based, wireless, or point of sale (retail, business, home) transaction connectivity. Transactions within the system can be performed from any location as the system contains a set of currency exchange features whereby payments, purchases, and credits of any format may be utilized, for instance physical currency, digital currency, credit, and barter.

The electronic currency exchange features of the present invention render the system independent of location factors which normally impact financial transactions that are geographically dispersed. In addition, the electronic currency exchange is configured for the exchange of incentive-based cash and near-cash items having a marketable value when exchanged either globally, as with currency, or with participating providers and vendors as with coupons, warrants, discounts and so forth. Traditional incentive business models require direct physical consumer participation based on paper-enabled manually intensive processes which are costly in relation to the profit-to-expense ratio of a vendor. The system of the present invention provides agent-based mechanisms for incenting users wherein users, or prospective users may be provided with inducements for an initial purchase as well as to increase purchase volume or frequency.

By way of example and not of limitation, incentives through post-sales activities can provide cash back from an electronic escrow account based on incentive purchase goals being met. The incentives oriented electronic commerce system of the present invention combines an application architecture of agent interaction upon a flexible and scalable backoffice architecture which provides for user independence regardless of transaction device form factor. The system is capable of performing streamlined transactions on behalf of the user, which in many cases can be performed automatically with zero manual intervention, or “zero-click”, from the user. Additionally, user interaction is simplified as all interfaces to which the user interact may be configured for visual and intellectual consistency regardless of form, usage, or location.

An object of the invention is to streamline e-Commerce transactions, in particular those performed in disparate locations.

Another object of the invention is to provide a system capable of deploying agent-based incentive programs.

Another object of the invention is to allow e-Commerce transactions to be performed by a user in relative anonymity, whereby information about the user need not be shared with the vendor for their indiscriminate use and sale to other vendors.

Another object of the invention is to create a system that is capable of fully automating events such as purchases, payments, and the management of incentives.

Another object of the invention is to provide a system that is capable of exchanging currencies electronically to facilitate performing transactions between parties at remote locations.

Another object of the invention is to simplify e-Commerce transactions utilizing an escrow account for a specific user in which identification, addressing, and financial data need be entered only once.

Another object of the invention is to provide transaction security wherein an e-Commerce transaction device contains an identifier that retains a secure association with an escrow account and personal information of the user.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a block diagram of an e-Commerce system according to an embodiment of the present invention which is shown with an escrow account and a currency exchange feature.

FIG. 2 is a block diagram of transaction processing units according to an aspect of the present invention shown connected with secure user input/output and vendor communication.

FIG. 3 is a flowchart of incentive processing according to an aspect of the present invention.

FIG. 4 is a flowchart of posting monetary incentives to an escrow account through an exchange rate mechanism shown according to an aspect of the present invention.

FIG. 5 is a flowchart of automatic transaction processing of recurrent transactions according to an aspect of the present invention.

FIG. 6 is a flowchart of automatic purchasing according to an aspect of the present invention.

FIG. 7 is a flowchart of secure user access to the agent-based incentive system according to an embodiment of the present invention.

FIG. 8 is a database schema for the agent-based incentive system according to an embodiment of the present invention, showing relationships between transaction device ID, user ID, and the tables associated with incentives, automatic payments, and the exchange of currency.

### DETAILED DESCRIPTION OF THE INVENTION

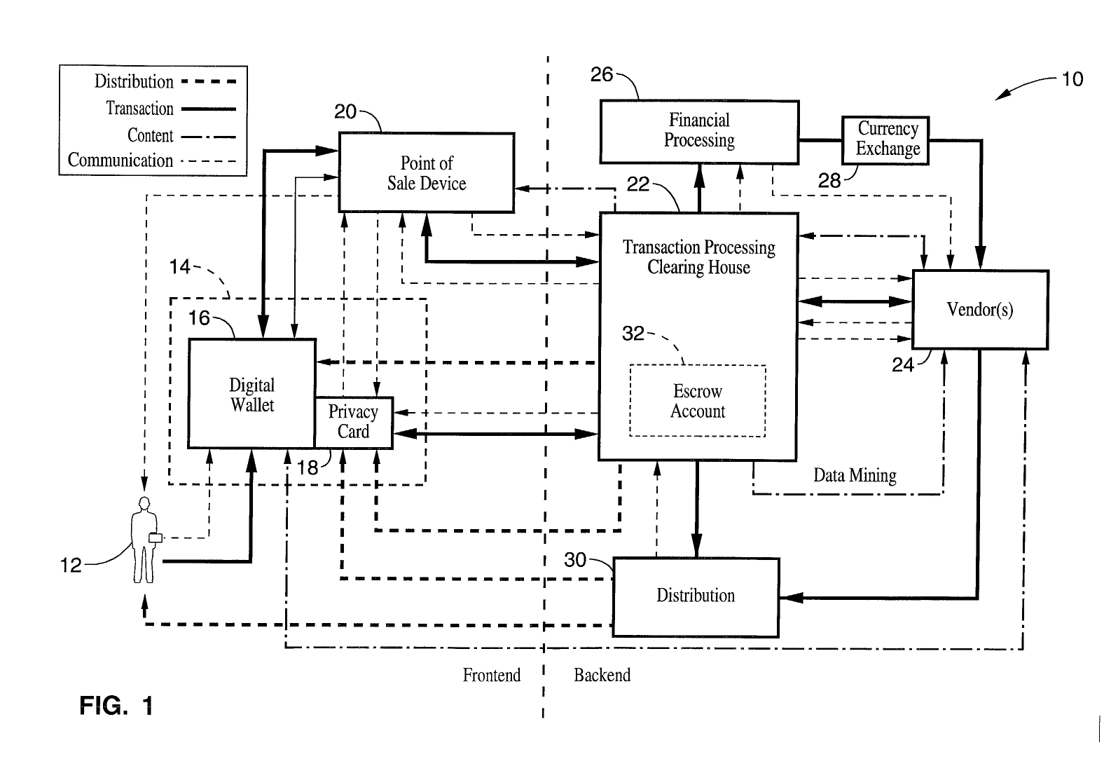

Referring more specifically to the drawings, for illustrative purposes the present invention is embodied in the method and apparatus generally shown in FIG. 1 through FIG. 8. It will be appreciated that the apparatus may vary as to configuration and as to details of the parts, and that the method may vary as to the specific steps and sequence, without departing from the basic concepts as disclosed herein.

Referring first to FIG. 1, an e-Commerce system 10 according to the invention is shown for providing support for electronic transactions between users and vendors while simultaneously affording incentive features along with automatic payments and the automatic exchange of currency during a transaction. In the embodiment shown, a user 12 utilizes a transaction device 14 such as a digital wallet 16 and privacy card 18. Transaction device 14 preferably contains an embedded unique identification wherein transactions for any specific unit may be individually and uniquely processed and registered. Note also that it is beneficial for the transaction device to contain one or more security features which identify the specific user of the device, wherein other parties gaining access to the transaction device would be unable to overcome the security features in order to utilize the device for making a purchase. Security features for transaction device 14 may include personal identification number (PIN) codes, biometric identification such as fingerprint recognition, or forms of access restriction. Note also that, while transaction device 14 is shown as comprising a digital wallet 16 and a privacy card 18, it will be appreciated that various forms of electronic implementations can serve as a transaction device. It will be further appreciated that devices designed for other purposes may also be configured as transaction devices, examples include electronic credit cards, cellular telephones, personal digital assistants, wristwatches, electronic books, notebook computers, and so forth.

Preferably, transactions are performed between transaction device 14 and an interface device capable of reading the identification number and interacting with the transaction device, such as a point of sale terminal 20, or other similar device. Transaction devices may be utilized with a variety of point of sale devices which, by way of example, can comprise retail terminals, kiosks, vending machines, and home based point of sale devices, in addition to both Internet and wireless appliances configured for interfacing with transaction devices. In addition, preferably a connection is provided between point of sale device 20 and a transaction processing clearing house (TPCH) 22. In the embodiment shown, TPCH 22 operates as an agent, or proxy, for user 12 by virtue of the known association between the transaction device ID and the user. Alternatively, the transaction device may communicate with TPCH 22 without the need of a point of sale system. TPCH 22 preferably maintains information about user 12, stored or indexed according to transaction device ID, and is capable of executing a transaction with a vendor 24 on behalf of user 12 without unnecessarily divulging personal information about user 12, and may automatically fill-in forms to facilitate a transaction on behalf of the user.

Transactions between TPCH 22 and vendor 24 are preferably facilitated by a financial processing unit 26 and a currency exchange unit 28. Financial processing unit 26 is capable of performing the actual financial transaction that may, for example, involve executing a cash or credit/debit operation, or provide for confirming that sufficient funds or credit exist to perform the transaction whereupon fees are transferred to the vendor to complete the transaction. Currency exchange unit 28 engenders e-Commerce transactions from different regions as well as the conversion of non-currency value units. Distribution of physical goods, downloaded goods, and services, is preferably controlled by a distribution center 30, which may be associated directly with the vendor or may be provided by a remote order fulfillment process. TPCH 22 is capable of interfacing with distribution center 30 to direct the distribution process, while preferably limiting the user information to which the vendor is accorded access. TPCH 22 preferably has an escrow account 32 associated with it that facilitates both conventional transactions and a variety of incentive programs.

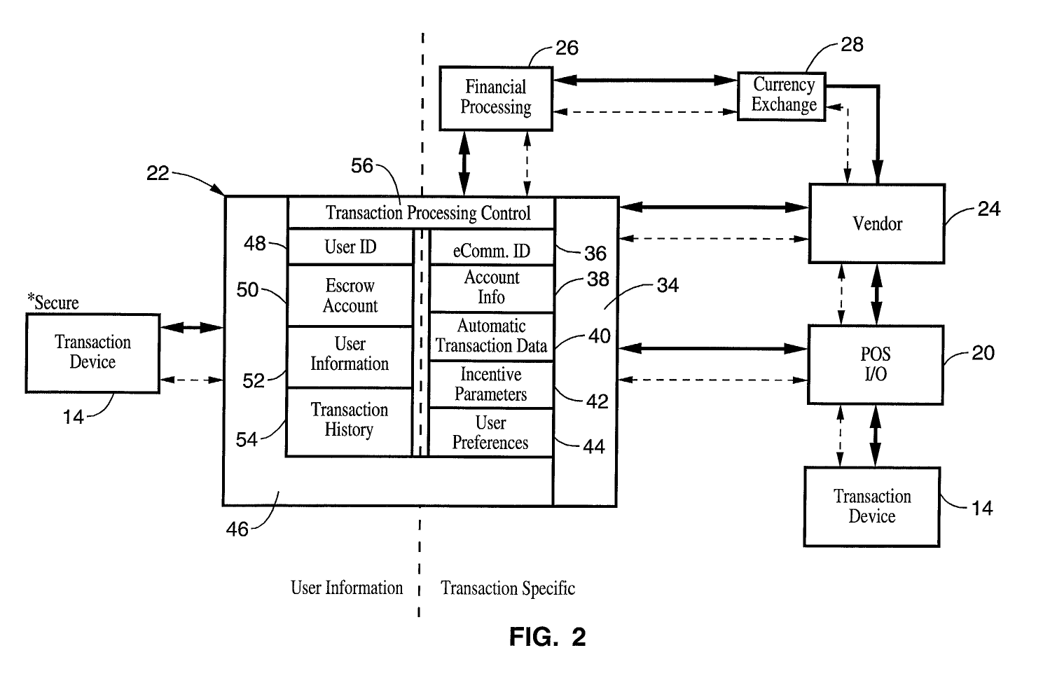

FIG. 2 depicts a set of representative execution and data structures to exemplify TPCH 22 in the embodiment of the invention thus described. The data within the TPCH 22 is exemplified as conceptually divided between those elements which are transaction specific and those elements which comprise user information that should be retained securely. It will be appreciated that the aforementioned division is conceptual, wherein the elements may exist within the same data structures yet are generally processed according to conceptual division such that user privacy is maintained.

An agent 34 within TPCH 22 interfaces with vendors 24 while acting on behalf of the user. The agent has access to one or more e-Commerce transaction device addresses 36 associated with the particular user, a collection of account information 38, a collection of data on automatic transactions 40, a collection of information relating to the processing of incentives 42, and a set of user preferences 44. Account information 38 provides the core information necessary to render a transaction, and is linked with various financial information tables from which transactions are sourced or received. Automatic transaction data 40 comprises user selections of inside vendors, selections of which vendors are to be paid automatically, and limitations as to maximum amount and details of the payments. Incentive parameters 42 are a set of user choices for determining which incentives are to be accepted and further for electing preferential forms of incentives. In addition, a queue, or list, is preferably maintained within the system within which all received electronic-based incentives, or references to physical incentive “coupons” are retained. User preferences 44 provide selections which generally define the desired operating constraints for agent 34. A input/output shell 46 allows the establishment of a secure link between the user and the TPCH 22 for establishing and altering device parameters as well as user identification and account information.

Transaction device 14 is shown in a secure connection mode with an input/output shell 46. The user information retained within TPCH 22 is shown as comprising a User ID 48, which uniquely identifies one specific user and is associated with one or more transaction device IDs. An escrow account 50 provides a repository of value units, such as monetary units, which may be utilized by the system when executing transactions. The escrow account is capable of receiving incentives from vendors and storing them for later use. User information 52 is capable of retaining all data that will be required for setting up transactions, and for notifying the user when interaction is necessary, or appears warranted. User information 52 includes identification information about the user which is required to initially activate an established account. By way of example, the identification information may comprise addresses, phone numbers, e-mail accounts, names of relatives, bank information, passwords, detailed personal information such as mother's maiden name, and other security and account related elements of information. A transaction history 54 contains a mechanism for logging transactions performed by the system. The transaction history, for example, may prevent redundant transactions, provide data for export to other programs/systems, and be utilized to generate notifications and summaries for the user. The operation of the TPCH 22 is shown under the direction of a transaction processing and control section 56, which administers the operations of the agent 34, input/output 46, and the use of information resources.

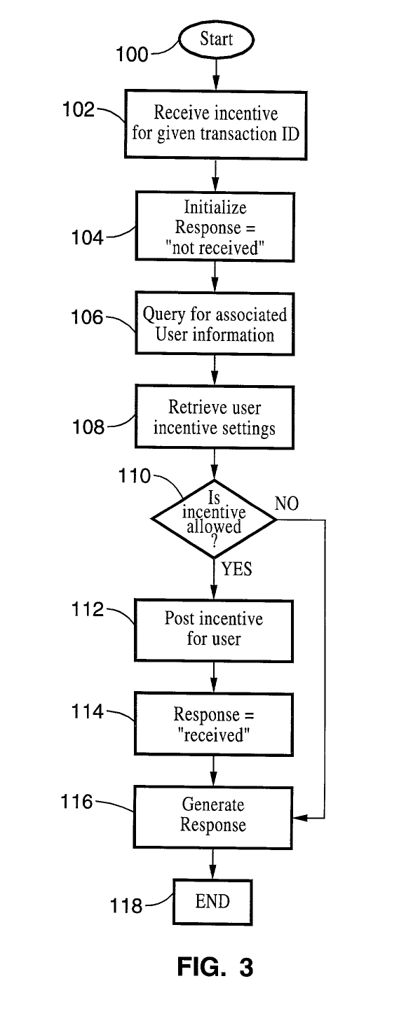

FIG. 3 exemplifies the processing of incentives within the present invention. Upon commencing processing at block 100, an incentive for a given transaction ID is received at block 102. The incentive is logged for the given transaction ID and the routine initialized according to a specific transaction device ID in block 104. A query retrieves the user ID of the user associated with the transaction device ID at block 106. The particular incentive is compared, in block 108, against the selection parameters set by the user. At Block 110, a determination is made as to whether an incentive is allowed; that is, whether the incentive matches allowance constraints. If an incentive is allowed, it is posted at block 112, for use, a “Received” notification is set at block 114, a response is generated and returned to the vendor at block 116 indicating posting, and processing this particular incentive terminates at block 118. Returning to block 110, if the incentive did not meet allowance constraints, the incentive would be rejected and a response generated and returned to the vendor at block 116. It will be appreciated that the simplified flowchart of FIG. 3 is shown by way of example only and that the invention may be variously implemented without departing from the teachings of the invention.

As a specific example of incentives accruing to a user, consider that during a thirty-day period a specific user has transacted a sufficient volume of business with a specific vendor, or qualifying vendors, to qualify for a rebate of $13.40 which is electronically credited to the user's electronic escrow account within the system. Upon paying a bill in the amount of $31.27 to the cable company, for example, all or part of the money in the escrow account may be utilized as part of the payment, either automatically or by manual selection.

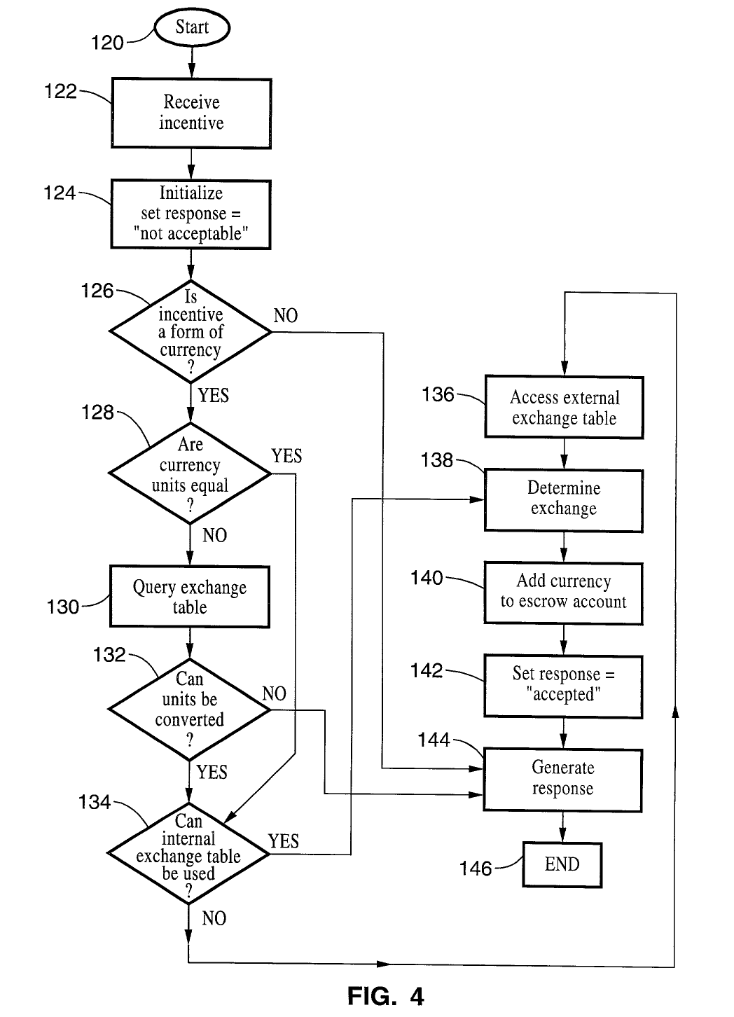

FIG. 4 exemplifies the process of posting monetary incentives to an escrow account based on an exchange rate. Processing of an incentive begins at block 120. Next, an incentive is received at block 122 and the routine is initialized at block 124. If the incentive is a form of currency, as checked in block 126, the process continues at block 128. On the other hand, if the incentive is determined at block 126 to not be in the form of currency, steps 128 through 142 are bypassed and a corresponding response is generated at block 144.

If the preferred currency units of the user do not match the offered currency units, as determined in block 128, then an exchange rate table is queried in block 130 and the process continues at block 132. On the other hand, if at block 128 the currency units are determined to be equal, blocks 130 and 132 are bypassed and the process continues at block 134.

If it is determined at block 132 that the offered units may be converted, then a decision as to the use of external or internal exchange tables are determined in block 134. Otherwise, if conversion is not possible, the conversion steps are bypassed and a response is generated at block 144. It will be appreciated that exchanges will often require external processes and the involvement of institutions, such as financial institutions, while the exchange of non-currency incentives generally require participation on the part of the specific vendor. An external exchange table, or process, is shown being accessed in block 136, wherein the exchange is configured at block 138. The transaction is then executed at block 140 which, in this instance, involves a currency value being added to the escrow account of the user. Pursuant to the exchange transaction, a response is created at block 142, and is then sent at block 144 to the incentive sender source, after which processing ends at block 146.

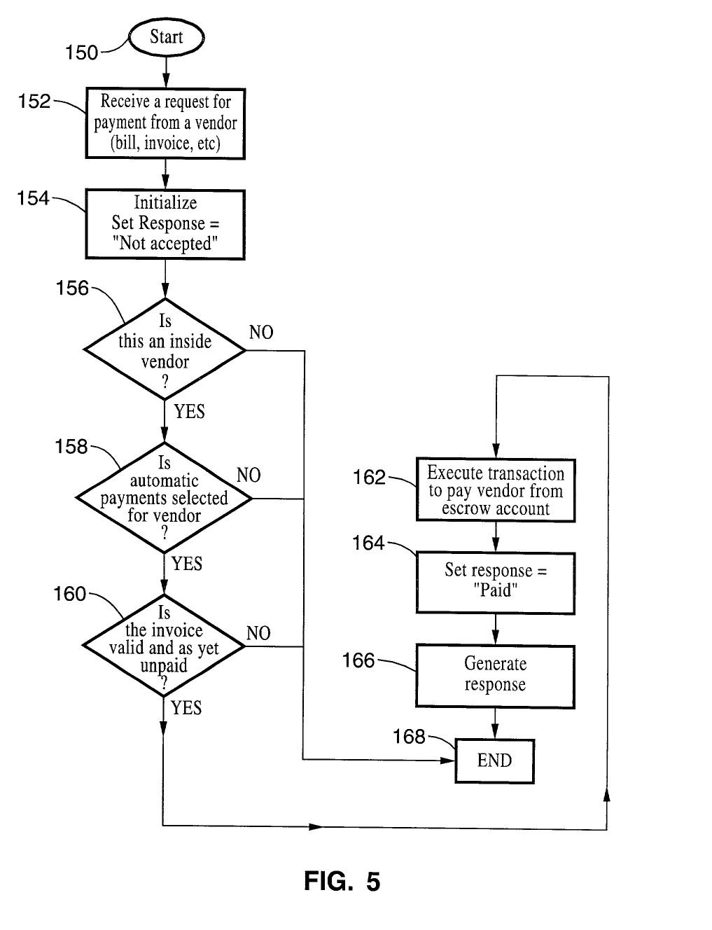

FIG. 5 exemplifies a process of automatic transaction processing according to the present invention. The present invention provides for automatic transactions, such as for the payment of recurrent invoices, bills, the payment of regular installments for which no electronic invoice is received, and for the automatic payment/purchase of items according to user selection and/or preferences. Automatic transactions can reduce the amount of mundane overhead to which the user is subject; however, it will be appreciated that features of the present system equally apply to consumer-initiated transactions. The payment of bills being so pervasive, the flowchart of FIG. 5 depicts the process of automatically paying a bill for which an electronic invoice, or electronic bill, has been received from the vendor. After commencing the process at block 150, a request for payment from a vendor is received at block 152. The automatic transaction process is then initialized in preparation for processing at block 154. Alternate payment events for the automatic transaction process include time-triggered events and externally-triggered events. Examples of time-triggered events include the payment of premiums, monthly payments, annuities, tithes, and so forth. Examples of externally-triggered events include the automatic payment for downloaded materials, selected product upgrades, backordered materials, contingent payment (awaiting one or more events), and the like.

The vendor requesting payment is identified and in block 156 a determination is made as to whether the vendor is an “inside” vendor to which the user has an ongoing relationship which is defined within TPCH 22. If the payment request is from a verified inside vendor, then the vendor information for the user is checked at block 158, to determine if the account is selected for automatic payment. If the request is not from an inside vendor, or if the request is from an inside vendor but automatic payments have not been selected, the process terminates at block 168.

If automatic payment is selected, then the parameters of the invoice are compared with criteria set up by the user, such as payment interval, maximum authorized payment, payment history, and selected payment times. The payment interval allows the setting of limits on how often the invoice may be honored within a given time interval, such as on a monthly basis. The maximum authorized payment defines the maximum level of payment that can be automatically generated to the particular vendor. As an example, consider water utility bills which have been selected for automatic payment up to a maximum of $40.00 wherein the transaction is to take place on the third Tuesday every third month (based on payment due dates). The user will be notified of water utility bills which exceed this maximum autopayment level of $40.00 as a distinct probability exists that the bill is in error, while the payment is not sent upon receipt but is retained until a time arrives which is proximal the due date. Preferably, the system and vendor can communicate additional information, such as by extensible markup language (XML), wherein cogent parameters of the transaction may be determined prior to possible execution. The checking of payment history is utilized to prevent redundantly paying the same invoice, or paying another incorrect invoice. If the received invoice, or bill, meets the automatic payment criterion as set forth by the user and has not otherwise been paid as determined at block 160, then the transaction is organized and executed in block 162 with payment being made from the escrow account, the escrow account in combination with another financial account, or the financial account in toto. Otherwise, the process terminates at block 168.

At block 164 a response is configured for payment having been made, at block 166 the response is generated so that the transaction is acknowledged, and processing is terminated at block 168. If the bill, or other event which initiated the automatic transaction routine, fails to meet any of the criterion for being automatically paid, then the associated payment is deferred to allow for manual intervention. In addition, the user may establish a set of notification conditions and parameters, such that they may be notified by the means they specify to any event occurring within the system. Examples of notification can include, bills exceeding the stated limits, multiple vendor payment requests, along with events that are indicated within the bill itself.

It will be appreciated that the system is configured to perform a transaction with the vendor system, and is capable of gathering information from the vendor about the specific payment request, therefore items comprising the specific payment request may be at issue and result in the generation of a notification event to the user. For example, a telephone bill is received with a $35 call to Peru charged to the user. If the user has established criterion for telephone bill paying that includes pausing automatic payment and notifying the user when a bill is received containing any non-domestic calls or 900 number calls—then the user will be notified and can take action early to clear up the disputed charges.

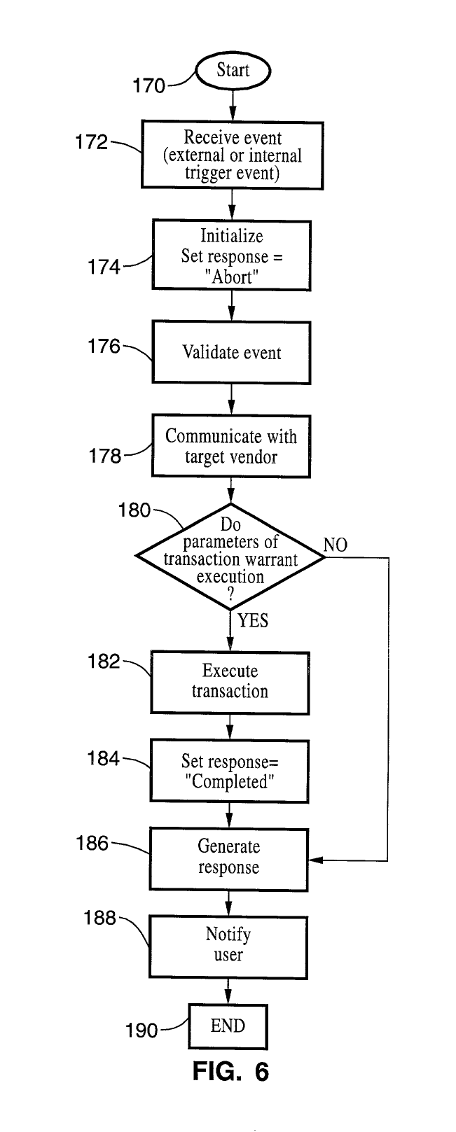

FIG. 6 exemplifies a process of automatically performing a transaction based on an event other than receipt of a vendor electronic invoice. The process commences at block 170. A relevant event is received at block 172 and process initialization takes place at block 174. The event is then validated in block 176, wherein the associated transaction, or transactions, triggered by the event are examined to determine if execution conditions have been met, and that the event itself has indeed occurred. A session is then opened with an external party, such as a vendor, at block 178 and automatic payment information is exchanged and compared against user selected transaction conditions, shown in block 180. If the conditions warranting execution of the transaction are not met, then the process continues at block 186 where a corresponding response is generated. If the conditions warranting execution of the transaction are met at block 180, the transaction associated with the event is executed, block 182, followed by establishing notification in block 184 and actual notification in block 188, after which the process terminates for this event 190. It will be appreciated that a variety of event conditions and associated transactions may be automatically processed according to the invention which allows the user to focus on more productive activities.

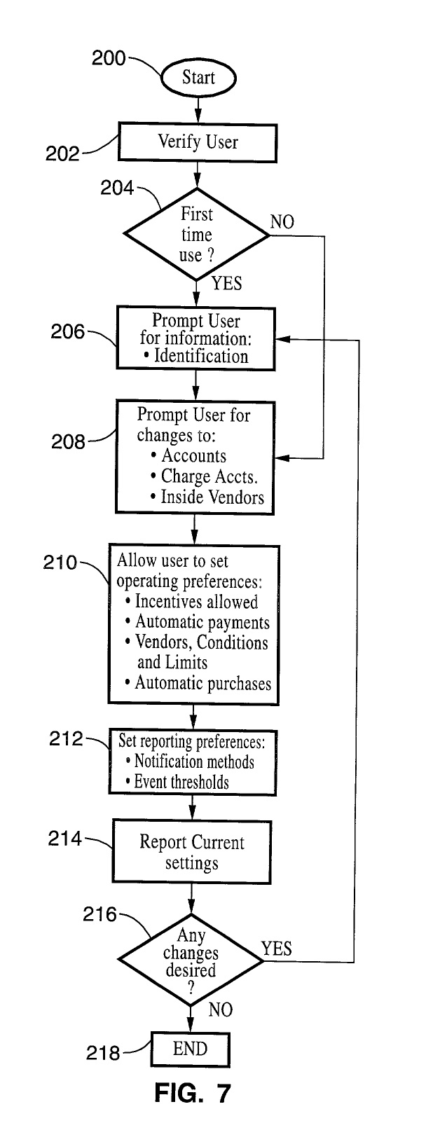

FIG. 7 exemplifies secure access to the agent-based incentive system of the present invention. The user is capable of gaining secure access to TPCH 22 for various purposes, which include initializing the system, updating account information, updating personal information, establishing operating criterion, and setting the parameters for incentives and automatic transactions. It is preferable that the user access TPCH 22 using a transaction device augmented with one or more additional security features, for instance the entry of an additional password. The transaction device of the user may be connected to TPCH 22 through various terminals, network mechanisms, or personal computer connectivity solutions. It will further be appreciated that a variety of wireless communication devices can link the transaction device to a network or system capable of providing an operable connection to TPCH 22. By way of example, TPCH 22 can be accessed directly over the internet (once requisite security has been abided by), by using a digital wallet with an IR device coupled through a PC, or by using a cellular telephone equipped for digital communication.

Once the user establishes communication with TPCH 22 at block 200, the identification of the user is further identified and verified at block 202. If the account on TPCH 22 is being opened for the first time as determined at block 204, then the user enters a session at block 206, for initially establishing/verifying identity and for establishing the necessary personal information required by the system. New users and existing users are capable of traversing a selection tree, such as a menu tree, in order to select the information that is to be entered, altered, or reviewed. Block 208 illustrates providing user selections in association with accounts (financial and non-financial), charge accounts (credit cards and merchant credit), as well as for establishing inside vendors. Additional selections are provided as per block 210 with user selections exemplified for incentives, automatic payments, vendors, and automatic purchases. Block 212 illustrates the setting of notification preferences, and the thresholds for events which are provided to trigger system events. The current settings are viewed at block 214 and the user is prompted for additional changes at block 216. If no additional changes are desired, then the process terminates at block 218 with the user being logged off.

The system may be deployed such that users register for an account on the incentive based system of the present invention and then initialize the system for their desired transactions. For example, the consumer may provide identification by way of a driver's license, and provide financial account information by providing information about a checking account, a savings account, an electronic brokerage account, and three credit cards. The consumer may then enter information regarding vendors to which they desire to execute transactions, such as water utility company, electric utility company, telephone service provider, a mortgage company, a vehicle lender, and a charity. The aforementioned elements may be entered within the system along with parameters for controlling the operations performed by the agent within the system by proxy for the user.

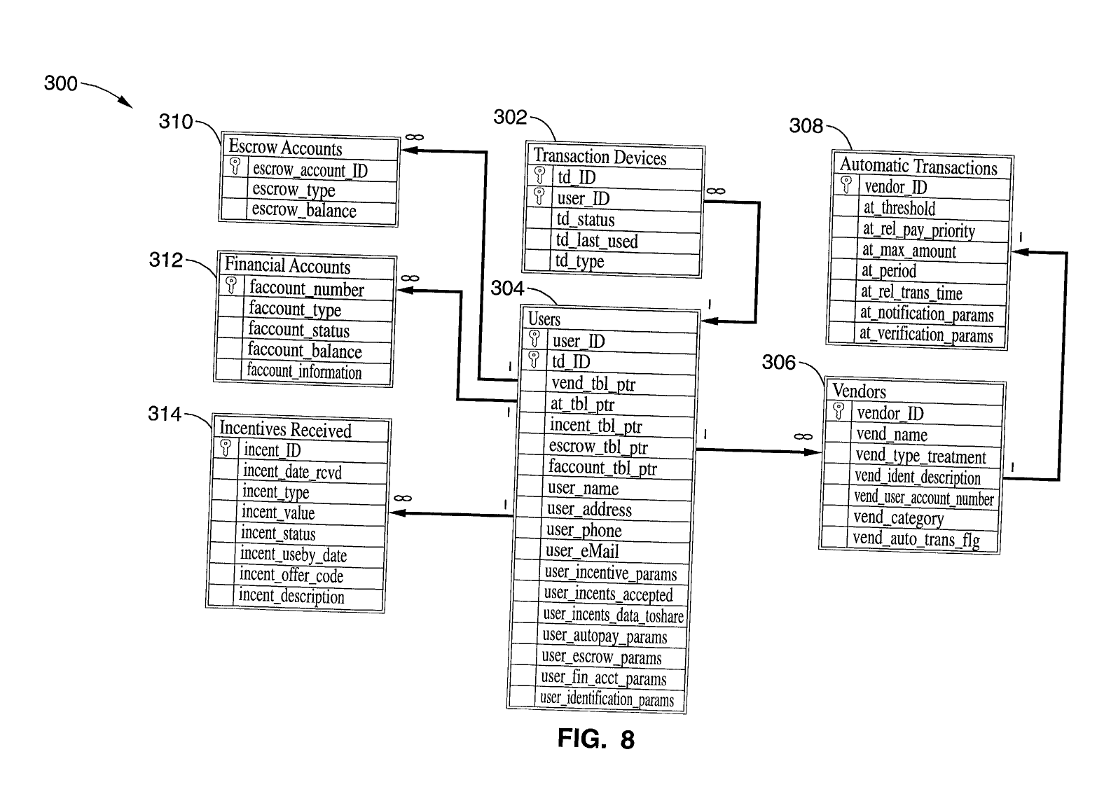

FIG. 8 illustrates an example of a database schema 300 for TPCH 22 which may be utilized within the incentive system according to the present invention. Numerous tables are shown in FIG. 8 by way of exemplifying the data structures relevant to the inventive features.

A table of transaction devices 302 contains entries for all transaction devices that are defined in relation to TPCH 22. Each transaction device record in TPCH 22 contains information which includes transaction device ID along with the ID of an associated user. Alternatively, the relationship between transaction device ID and user ID could be retrieved by query of the user table which contains an index by transaction device ID, however, this would slow the system. The transaction device table 302 preferably contains information that may be directly utilized by the agent within TPCH 22 without reference to the particular user, for instance, the status of the transaction device (i.e. active, inactive, stolen, and so forth), the date and time of prior use, and information about the type of transaction device being utilized so that proper interfacing may be facilitated. It will be appreciated that the various point of sale and other related vendor systems do not have direct access to any of the system tables, such as the transaction device table, however, the tables are organized to speed utilization by the agent and the transaction processing routines.

A many-to-one relationship exists between the transaction device table 302 and the user table 304, as a single user may utilize multiple devices. Records on the user table 304 provide information about each user defined within TPCH 22. In addition, the remaining tables shown on the page are instantiated for each particular user. The information within the user table contains identification information about the user, operational criteria as set forth by the user in relation to the features of the system, as well as table pointers for gathering multi-entry information from additional tables. System tables common to all users are not shown in FIG. 8 as they would be similar to conventional systems that contain user records. In the table of users 304 it will be seen that the user has access to setting groups of parameters for incentive processing, automatic payment processing, and the escrow accounts within the system. For clarity these groups of related parameters are exemplified as a single entry.

Associated with each user is a set of vendor records within a vendor table 306. The general purpose of an e-Commerce system is to speed and simplify transactions between a user community and a vendor community. Each user within the user community has established a unique relationship with select vendors within the vendor community. The vendor table 306 provides a mechanism for retaining a list of vendor relationships. It is expected that the vendor list will be substantially populated with records of inside vendors, however, other forms of relationships may also be represented by the exemplified vend_type_treatment field, such as vendors that incentives should not be accepted from; vendors which are competitors, or vendors to avoid; for instance, due to a regrettable past experience. Information is provided within the vendor table, or associated tables, to fully identify the vendor and to secure the transactions performed with the specified vendor, insofar as such transactions are allowed. The vendor category is preferably specified wherein the agent operation can take into account the vendor category, as it will be appreciated that a payment transaction with a mortgage company (category=loan payment, mortgage) is inherently different from transactions carried out with a stationary supply retailer (category=retailer, stationary). Numerous category designations may be supported within the system to accommodate any desired level of specificity. The exemplified vend_category field, for instance, may comprise primary entries of: utility bills, loan payment, charge cards, subscription, insurance, medical, investment, charity, retailer, purchase order, and so forth. Additional tables may be associated with the vendor table, for instance an automatic transaction table containing records which define when and how automatic transactions are to be executed with each particular vendor.

A single automatic transaction table 308 is depicted in FIG. 8 having a one-to-one relationship with the vendor table, and keyed to the vendor ID field. The information within the field vend_auto_trans_flg indicates if any automatic transactions can be performed with the vendor, wherein the automatic transaction table is populated with records only for those vendors to which some level of automatic transactions may be performed. Exemplified within the automatic transaction table are fields for establishing guidelines for determining if a transaction is to be automatically performed. The at_max_amount sets the upper limit on automatic transactions associated with this vendor. The at_trans_threshold field contains information to determine an account threshold for the automatic payment to a vendor, or account. For example, if a consumer had established a recurring monthly transaction for transferring money from a checking account to a savings account, then it would be prudent to configure the transaction threshold to a limit that would leave sufficient funds within the checking account for the payment of upcoming bills. Prior to performing the automatic transfer, the system would compare the checking balance against the threshold and if the balance was found to be less than the transaction threshold then the automatic monthly transfer to savings would be postposed and the consumer notified. It will be appreciated that the aforementioned mechanism provides an additional method for prioritizing cash disbursements. In addition, a related field at_rel_pay_priority allows the direct assignment of priorities in relation to the disbursement of funds pursuant to the available cash threshold. Additionally, information relating to normal parameters of the transaction are provided, such as the interval of payments, the time of month, or year, that the bill should be paid and similar criterion for selecting items for automatic payment. Furthermore, options are provided to facilitate informing the user of specific issues which arise and for requesting user verification of certain transactions prior to execution.

Transaction processing within TPCH 22 is exemplified with associated escrow accounts, such as could be represented within the escrow accounts table 310, wherein value units may be stored. These value units typically comprise monetary units converted to the currency format desired by the user, however, various non-monetary units may additionally be stored. Examples of non-monetary units which may be retained within separate escrow accounts containing homologous entries include, frequent-flyer miles, “bonus-buck” coupons and other non-vendor specific value units. Each escrow account contains information about the entries within the account, which are preferably agglomerated to arrive at balance information for the escrow account. It will be appreciated, however, that separate offers (i.e. coupons) which are incapable of agglomeration, may be stored for retrieval within the escrow accounts, but are preferably stored as incentives. Associated with the user may be a plurality of financial accounts maintained external to, or in cooperation with, the described incentive system of the present invention. These financial accounts will generally comprise cash accounts and credit card accounts, however, other forms of financial accounts may be represented for the dispersal or receipt of funds.

A table of user financial accounts 312 contains entries defining each financial account that the user desires TPCH 22 to have interoperability with, along with information about how to communication with the account, account security, and preferably a snapshot of account status. Transaction processing within the system is preferably capable of performing intermediary transactions with financial institutions in association with the represented financial accounts, so as to facilitate the performance of transactions on behalf of the user. Institutions are continually competing for the attention of those within the user community and liberally utilize incentives for both garnering user attention as well as for retaining customer loyalty and awareness. The system of the present invention provides for controlled and simplified exchange of these incentives.

An incentives table 314 contains entries that either provide all relevant details of an incentive, or indirect information associated with an incentive which may be contained elsewhere. Electronic incentives may be received within the system through the transaction device of the user, for instance at the point of sale, or over a network that is capable of communicating with TPCH 22, such as over the internet. The system provides the user with control over the types of incentives received as well as the maintenance and tracking of those incentives. Sufficient data is retained about each incentive within the fields of each record within the incentive table 314 to allow the incentive to be utilized within a transactions. It will be appreciated that the user need not be cognizant of the various incentives which are contained within the incentives table, because the system prior to executing a transaction will attempt to automatically redeem any potentially applicable incentives. It will be further appreciated that incentives provide an “advantage” which is redeemable during a transaction associated with the transaction device. These “advantages” stored within the incentives table need not have expiration dates and can be maintained within the incentive table as a stationary (non-expiring) entry. Examples of fixed incentive entries include discount cards (e.g. automobile club), and associations (e.g. retired military officers association). Furthermore, it will be appreciated that other forms of “advantage” may additionally be retained, such as club memberships, key cards, hotel keys, and so forth which are subject to “redemption” when the transaction device is in operable communication with a point of sale, or other related form of terminal. To exemplify these uses consider a membership card to a health spa contained within the incentives table linked to the transaction device. A terminal in the spa communicates through the transaction device and is provided with user information sufficient to activate an admittance system which as a result allows the user to enter. Numerous examples of use can be considered for the collection of “advantage” within the incentive table. It will be appreciated that while communicating for the purpose of granting access, the “point-of-sale” system of the spa may provide additional information to the transaction device, which could for example include billing reminders, special program reminders, schedules of events, and incentives.

Accordingly, it will be seen that this invention provides an e-Commerce system that is capable of operating on behalf of a user to facilitate various transactions which include the processing of incentives. It will be appreciated that the invention embodied herein may be implemented as separate system units, or integrated in association with another system while still adhering to the teachings of the invention. Furthermore, it should be appreciated that the specific implementation details were provided by way of example, as systems may execute transaction processing using a variety of specific hardware and software which may be utilized in combination.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for performing electronic commerce transactions, comprising:
(a) a transaction terminal configured to receive a user transaction device that provides a device identifier when coupled to the transaction terminal, said transaction terminal further configured to indicate that a transaction is to be performed;
(b) a transaction privacy clearing house configured to communicate with the transaction device when a transaction is to be performed, said transaction privacy clearinghouse further configured for receipt of said device identifier and capable thereupon of authorizing a transaction on behalf of a user associated with said device identifier after the identity of said user has been verified; and
(c) an escrow account associated with the transaction privacy clearing house which is configured for receiving and dispersing forms of remuneration associated with authorized transactions.

2. A system as recited in claim 1, further comprising an automatic recurrent transaction execution unit configured to automatically perform a transaction upon receiving a selected invoice or bill from a vendor that meets certain predetermined verification criterion.

3. A system as recited in claim 2, wherein the predetermined criterion comprises the determination that the vendor is a valid inside vendor that has been user selected for automatic payments.

4. A system as recited in claim 2, wherein the predetermined criterion comprises the determination that said invoice, or bill, received from said vendor is for a valid amount, and has not already been paid.

5. A system as recited in claim 1, further comprising an automatic purchases execution unit configured to perform selected financial transactions on behalf of the user according to user selected criterion.

6. A system as recited in claim 1, further comprising an incentive processing unit configured to accept forms of remuneration from a vendor for a user whose device identifier is provided, wherein the remuneration is credited to an account of the user.

7. A system as recited in claim 6, wherein the remuneration is credited as a received cash transaction within the escrow account of the user.

8. A system as recited in claim 6, wherein the remuneration is credited as an offer for which information is received and stored, the use thereof providing enablement of the associated offer.

9. A system as recited in claim 8, wherein the incentive processing unit is configured to accept non-currency offers in accord with user selected criterion, such as for specific products or services.

10. A system as recited in claim 6, wherein the forms of remuneration received are selectable from the group of remuneration forms consisting of physical currency, digital currency, coupons, warrants, discounts, or barter units.

11. An apparatus for performing electronic commerce transactions according to programming executable on a computational device, comprising:
(a) a transaction system which provides a clearing house for user transactions; and
(b) an escrow account operable within the transaction system which includes a secure database of active accounts that are configured for disbursing or receiving units of exchange in response to user authorized transactions.

12. An apparatus as recited in claim 11, wherein user authorization is provided by way of either manual selection, or by proxy as controlled by user established parameters.

13. An apparatus as recited in claim 11, wherein the unit of exchange comprises monetary funds.

14. An apparatus as recited in claim 11, wherein the escrow account is configured for separate receipt and disbursement of non-currency forms of exchange, such as frequent-flyer programs.

15. A method for permitting users to conduct electronic commerce transactions, the method comprising:
providing a transaction device having a transaction device identifier to a user to be associated with the transaction device identifier;
maintaining within a secure server an association between the user and the transaction device;
maintaining within a secure server an electronic escrow account in association with the user; and
conducting an electronic commerce transaction with a vendor using the transaction device.

16. A method as recited in claim 15, wherein the escrow account is initialized by the user upon initial registration and may thereafter receive additional units of remuneration from either the user or a vendor.

17. A method as recited in claim 15, wherein the electronic escrow account is configured to transfer forms of remuneration in an amount associated with the transaction.

18. A method as recited in claim 17, wherein the different forms of remuneration are exchanged between the electronic escrow account of the user and the vendor during the electronic commerce transaction.

19. A method as recited in claim 18, wherein the exchange of different forms of remuneration are performed according to an exchange rate table.

20. A method as recited in claim 19, wherein an exchange rate table maintained outside of the system is consulted in preparation for performing the electronic commerce transaction.

21. A method as recited in claim 18, wherein the forms of remuneration are selected from the group of remuneration forms consisting of physical currency, digital currency, credit vouchers, coupons, certificates, stocks, barter units, and warrants.

22. A method as recited in claim 15, further comprising automatic authorization of recurrent transactions wherein selected invoices, bills which are received from a vendor and meet certain predetermined verification criterion are paid automatically from the escrow account.

23. A method as recited in claim 15, further comprising automatic execution of recurrent purchase transactions wherein user-approved cash purchase orders are automatically transacted from the escrow account with predetermined vendors.
